(19) United States
(12) Patent Application Publication
(10) Pub. No.: US 2023/0416016 A1
(43) Pub. Date: Dec. 28, 2023

(54) MULTI-COMPARTMENT END STATION FOR A SORTING SYSTEM

(71) Applicant: SIEMENS AKTIENGESELLSCHAFT, München (DE)

(72) Inventors: Bertram Wanner, Meersburg (DE); Rolf-Peter Skrdlant, Überlingen (DE); Felix Fischer, Konstanz (DE); Dirk-Udo Eisser, Reichenau (DE); Carsten Aschpurwis, Konstanz (DE)

(21) Appl. No.: 18/252,894

(22) PCT Filed: Nov. 1, 2021
(86) PCT No.: PCT/EP2021/080230

§ 371 Date: May 15, 2023

(30) Foreign Application Priority Data
Nov. 16, 2020 (EP) 20207859.8

(51) Int. Cl. B65G 47/71; B65G 47/46

(52) U.S. Cl. CPC B65G 47/71; B65G 47/46

(57) ABSTRACT

A terminal for a sorting plant for sorting piece goods includes a receiving device, a transport device and a row arrangement of terminal stations arranged in a row, wherein the receiving device is configured to receive piece goods from a sorter outlet of a sorter of the sorting plant and to deliver the piece goods to the transport device, wherein the transport device includes a transport unit which is movable to each of the terminal stations arranged in the row, and wherein the transport device is configured to take over the piece goods discharged from the receiving device and to transport the piece goods with the transport unit to a desired terminal station of the terminal stations arranged in the row and to discharge the piece goods into this desired terminal station.

### BACKGROUND

The invention relates to the technical field of sorting systems for piece goods and, in particular, to terminal equipment and terminal devices of sorting systems for piece goods.

Up to now, there have been a maximum of two end-of-line bins at a discharge position on the sorter, to the left and right of the sorter. Partly sorters are arranged one above the other or branched after the discharge from the sorter in the chutes by mechanical devices. Here the possibilities are limited, because the conveyed goods are not actively transported. More end points are thus practically only possible by extending the sorter.

Operators of sorting facilities for general cargo, such as postal or parcel services, but also operators of sorting facilities at airports, often have to sort a large number of general cargo into a large number of sorting destinations in a limited area. The limited space is therefore contrary to the desire for a high sorting depth. This can be countered by increasing the number of sorting passes, but this makes sorting as a whole more complex and slower.

The present invention is therefore based on the task of enabling an increase in the sorting depth of a sorting system.

### SUMMARY

According to one aspect, the task is solved by an end position device. The end position device is provided for a sorting system for sorting piece goods. The end position device comprises a receiving device, a transport device and a row arrangement of end positions arranged in a row. The pick-up device is designed to take over a piece of material from a sorter outlet of a sorter of the sorting plant and to deliver it to the transport device. The transport device comprises a transport unit which can be moved to each of the end points arranged in the row. The transport device is designed to take over the piece goods delivered by the receiving device into the transport unit, to transport the piece goods in or on the transport unit to a desired end point of the end points arranged in the row and to deliver the piece goods into this desired end point.

This means that significantly more end positions can be accommodated on an available area than was previously the case. In this way, a greater sorting depth can be achieved and sorting can be carried out in fewer sorting operations than before, which significantly reduces costs.

According to one embodiment, the receiving device comprises a buffer to buffer the piece goods received by the sorter output. The transport device is designed to move the transport unit to the intermediate storage. The intermediate storage is designed to deliver the piece goods to the transport unit. This allows the sorter to be decoupled from the end points. Thus, recirculation on the sorter can be prevented or minimized. The buffer also has the effect of calming the transport goods after transfer from the sorter, the transfer preferably comprising a dynamic discharge from a non-resting load carrier and a subsequent sliding process on the pick-up device.

Depending on the application, the pick-up device may include one or more intermediate accumulators. In many cases, depending on the design of the sorting system or the terminal arrangement, a significant increase in performance can already be achieved by the presence of a single intermediate store in the receiving device, while the additional benefit of a second intermediate store or further intermediate stores in the terminal device exists, but is less significant than the benefit of the first intermediate store.

According to one embodiment, the sorter comprises several sorter outlets and is designed to discharge piece goods laterally from the main conveying direction of the sorter out of the sorter outlets or vertically downwards to the main conveying direction of the sorter.

According to one example, the row of end points at the sorter outlet is arranged transversely to the main conveying direction of the sorter. Advantageously, the transport device is designed to move the transport unit linearly according to the row arrangement of the end positions, also transversely to the main conveying direction of the sorter, in order to deliver the piece goods to the desired end position. In this way, a particularly large number of end points can be served by one sorter outlet at a short distance from one sorter outlet to the next sorter outlet. According to one embodiment, the row of end points is arranged orthogonally to the main conveying direction of the sorter.

According to one example, each transport unit is assigned a single linear row arrangement of end points, and the transport device is designed to discharge piece goods exclusively into the end points of this row arrangement. By linear is meant a one-dimensional arrangement of end points in a line. Preferably the transport device extends above the row arrangement along this line.

According to an embodiment example, the transport device comprises a drive which is designed to actively drive the transport unit. This enables an active transport of the piece goods. This means that less or no passive transport means, such as chutes, are necessary, which allows a high functional safety, a very high packing density of the end positions and the accommodation of more end positions on a given area.

According to one embodiment, the transport unit is designed as a sliding carriage. This makes it possible to realize a simple transport device that cooperates efficiently with the row arrangement of the end positions.

According to one embodiment, the sliding carriage is track-guided. This makes it possible to realize a simple transport device that interacts efficiently with the row arrangement of the end positions.

According to one embodiment, the transport unit is or comprises no automated guided vehicle (AGV). This makes it possible to realize a simple transport device that interacts efficiently with the row arrangement of the end stations. In an alternative embodiment, however, the transport unit can comprise an AGV.

According to one example, the transport unit comprises a belt conveyor which is designed to discharge the piece goods. This makes it possible to realize a reliable and, in particular with regard to the vertical height, space-saving device for transferring the piece goods from the transport unit to the end points.

According to an embodiment example, a conveyor belt of the belt conveyor comprises separating elements, which define at least one segment, or which divide the conveyor belt into segments.

This makes it possible to create a defined and cost-effective pick-up location for the piece goods on the transport unit with little effort.

According to an embodiment example, the terminal device, the terminal device or the sorting device comprises a control device. The control device is adapted to control the pick-up device and the transport device and to ensure the transfer of the piece goods from the pick-up device to the transport device and the delivery of the piece goods from the transport device to the desired end point.

According to one example, the control device is adapted to control the end-of-line device and/or the end-of-line device and/or the sorting system in such a way that at any time a maximum of one piece of material is stored in the buffer. For example, the control device is adapted to memorize whether the intermediate storage is occupied and, as long as it is occupied, to prevent a further delivery of a further piece of material to this intermediate storage. This makes it possible to avoid complicated individual handling of piece goods that are in the buffer at the same time. The term “buffering” includes all operations or capabilities of the buffer to store a unit load. If, for example, one of the intermediate stores consists of a flat receiving surface on which the piece goods rest, this is also to be understood as storing in the intermediate store.

According to an embodiment example, the control device is adapted to control the end position device and/or the end position device and/or the sorting installation in such a way that a first and a second piece goods delivered by the sorter to the receiving device are simultaneously received in the intermediate storage, provided that they are to be sorted into the same end position. The control device is preferably also adapted to control the end position device and/or the end position device and/or the sorting installation in such a way that it is prevented that between the first and the second piece goods a further piece good is delivered by the sorter to the receiving device, which is to be sorted into a different end position.

According to an embodiment example, the end position device comprises a pull-out drawer device. The end positions are arranged in a row in the drawer device. This ensures easy access to the end positions, for example for maintenance purposes, even in a compact design. Preferably, the end position device is extendable in the longitudinal direction of the row. This allows the drawer device to be extended even if it is directly adjacent to the sides of further drawer devices or row arrangements of end locations due to a compact design. According to one embodiment, the drawer device comprises exactly one drawer. According to a further example, the drawer device comprises exactly two drawers which can be extended in opposite directions. This allows the drawer size to be reduced and the space to be provided for the extended drawers to be optimized.

According to an embodiment example, the end station device comprises a collecting belt conveyor device arranged below the row arrangement. Each of the end stations is designed to discharge the piece goods contained therein in a group onto the collecting belt conveyor device. The collecting belt conveyor is designed to transport the piece goods in the group. In this way several end points of the same or different end point devices can be emptied in a simple manner by means of a single collecting belt.

According to one embodiment, each sorter outlet is associated with exactly one end-of-line device. Each end position device comprises exactly one linear transport device arranged over a one-dimensional linear row arrangement of end positions for discharging piece goods into a desired one of said end positions. Preferably, each terminal device also comprises exactly one buffer.

According to a further aspect, the task of enabling an increase in the sorting depth of a sorting system is solved by a terminal device. The end-of-line device comprises a plurality of end-of-line devices as described above. Each of the end-of-line devices is configured to cooperate with a sorter outlet of a sorter to pick up piece goods from the sorter outlet and deliver them to its transport device.

According to a further aspect, the task of enabling an increase in the sorting depth of a sorting plant is solved by a sorting plant. The sorting plant comprises a sorter and one or more of the terminal devices described above or one or more of the terminal devices described above.

According to a further aspect, the task is solved by a method for sorting piece goods, in the context of which a piece good is transferred from a sorter outlet of a sorter to a receiving device of a terminal device. The receiving device delivers the piece goods to a transport unit of a transport device. The transport unit is assigned a row arrangement of end points arranged in a row. The transport unit is movable to each of the end points arranged in the row arrangement. The piece goods delivered to the transport unit are transported by means of the transport unit to a desired end point of the end points arranged in the row and are transferred by the transport unit to this desired end point.

According to one embodiment, the piece goods are temporarily stored in one or more intermediate stores of the receiving device before the piece goods are delivered from the receiving device to the transport unit. The transport unit is moved to the intermediate storage. The intermediate store delivers the piece goods to the transport unit.

According to one embodiment, the piece goods are discharged from the sorter outlet sideways to the main conveying direction of the sorter or vertically downwards to the main conveying direction of the sorter.

According to one embodiment, the row arrangement of the end positions at the sorter exit is arranged transversely to the main conveying direction of the sorter.

According to one example, a single linear row arrangement is assigned to the transport unit. The transport device is designed to deliver piece goods exclusively to the end points of this row arrangement.

According to an embodiment example, the transport device comprises a drive which is designed to actively drive the transport unit.

According to one example, the transport unit is designed as a sliding carriage, which can preferably be guided in one track.

According to an embodiment example, the transport unit comprises a belt conveyor which is designed to discharge the piece goods.

According to an embodiment example, a conveyor belt of the belt conveyor comprises separating elements, which define at least one segment, or which divide the conveyor belt into segments.

According to one embodiment, a control device controls the pick-up device and the transport device to affect the transfer of the piece goods from the pick-up device to the transport device and the delivery of the piece goods from the transport device to the desired end point.

According to one embodiment, the control device controls the end position device, the sorter and/or the pick-up device in such a way that at any given time a maximum of one piece of material is picked up in the buffer.

According to an embodiment example, the control device controls the terminal device and/or the terminal device and/or the sorting device in such a way that a first and a second item delivered by the sorter to the receiving device are stored simultaneously in the buffer, provided that they are to be sorted into the same terminal.

According to one embodiment, the end points arranged in a row are arranged in a pull-out drawer.

According to one example, the terminal station is designed to deliver the piece goods contained therein in a group onto a collecting belt conveyor device, and the collecting belt conveyor device is designed to transport the piece goods away in the group.

### BRIEF DESCRIPTION OF THE DRAWINGS

Further features, properties and advantages of the present invention will be apparent from the following description with reference to the accompanying figures. In the examples of embodiments and figures, the same or similarly acting elements may in each case be provided with the same reference signs. The elements shown and their proportions among each other are not to be regarded as true to scale, rather individual elements may be shown in larger proportions for better representability and/or better understanding. Thereby show:

FIG. 1 shows a schematic top view of a sorting system comprising several terminal devices according to an example of the invention; and

FIG. 2 shows a schematic side view of a section of the sorting system and a terminal device of FIG. 1.

### DETAILED DESCRIPTION

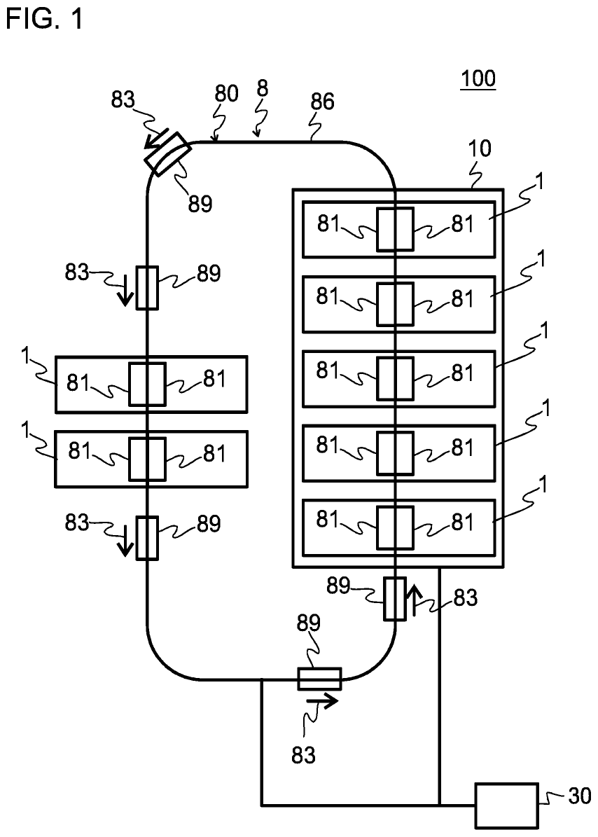

FIG. 1 shows a sorting system 100 according to an embodiment of the invention. The sorting plant 100 comprises a sorter 8 and several end position devices 1. The end position devices 1 may be comprised by an end position device 10.

The sorter 8 comprises a conveyor system 80 and sorter outlets 81. The conveyor system 80 comprises a conveyor path 86 and load carriers 89 and is designed to convey the load carriers 89 along the conveyor path 86. The sorter outlets 81 are arranged and configured along the conveying path 86 in such a way that a piece good 5 can be discharged from the sorter 8 by the load carriers 89 via a desired sorter outlet 81. The load carriers 89 are designed to pick up a piece 5 for transport along the conveying path and to transfer it to a desired sorter outlet 81 in order to discharge the piece 5 from the sorter. In the example shown in FIG. 1, the sorter 8 is designed as a circulating circular sorter on which the load carriers 89 circulate in a closed conveying path 86.

A load carrier 89 may comprise at least one discharge element, for example a tilting tray or a cross belt (in the technical field also often called cross belt), which is arranged to transfer the piece goods 5 to a sorter outlet and thus to discharge them from the sorter. Alternatively, or additionally, a load carrier 89 can also comprise a discharge chute (also called bombay) which discharges the piece goods 5 downwards into a sorter outlet arranged on an underside of the conveyor path 86 and thus discharges them from the sorter 8.

In further variants, the sorter is not a circular sorter but another suitable sorter, for example a linear sorter. The load carriers can be guided along the track as part of a coherent train composition or individually.

According to further examples, the load carriers are enclosed by a driverless transport vehicle and are conveyed by the latter in a non-lane-guided manner. The English translation “Automated Guided Vehicle” is often used as a synonym for the term “Driverless Transport Vehicle”. In this variant, the sorter includes a lane intended for the AGVs to drive on, which also leaves room for an AGV to maneuver or overtake other AGVs.

According to embodiments, the conveyor path 86 comprises a conveyor belt on which the load carriers are mounted. According to further variants, the conveyor path comprises a carousel on which the load carriers are mounted, or a rope hoist to which the load carriers are coupled.

In the example shown in FIG. 1, two sorter outputs 81 are arranged on the left and right sides of the track as a pair of sorter outputs. In further variants, however, the sorter outputs 81 can also be arranged on only one side of the sorter 8, for example only on the outer side of the circular sorter 8, or only on its inner side. Likewise, the sorter outputs 81 can be arranged individually, i.e., not as a sorter output pair, laterally to the left and right of the conveyor path 86 as required.

Each of the terminal devices 1 is configured to interact with at least one sorter outlet 81 of the sorter 8, respectively, to pick up piece goods from the sorter outlet 81 and deliver them to its transport device 4.

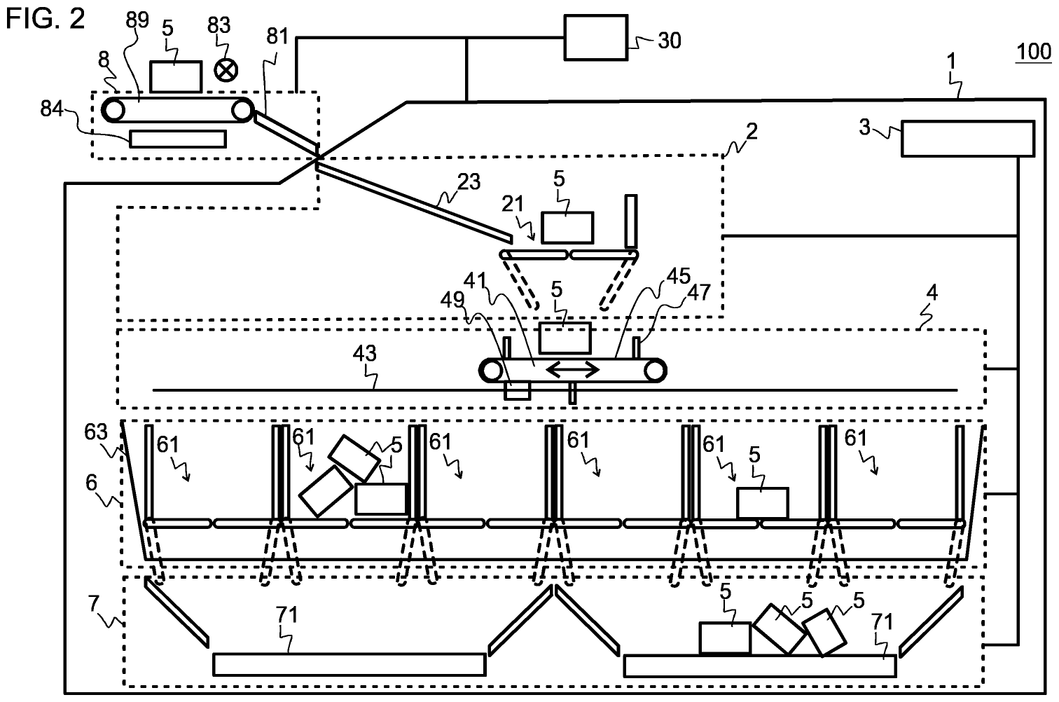

FIG. 2 shows a schematic side view through a section of the sorting system 100 of FIG. 1 according to a further specific version. The sorting plant 100 comprises the sorter 8 and the end position device 1.

In the variant shown in FIG. 2, the sorter 8 comprises a conveyor 84, for example a conveyor belt, which conveys load carriers 89 arranged on the conveyor 84 along the conveyor path 86. The load carriers 89 comprise a drivable crossbelt which is designed to transport unit loads along the conveying path 86 and to discharge them at the sorter outlet 81 laterally to the main conveying direction 83 onto the sorter outlet 81 which is designed as a chute. By “main conveying direction” is meant the local main conveying direction, since for a circular sorter the velocity vector in three-dimensional space cannot be the same at every point of the closed path.

The terminal device 1 comprises a receiving device 2, a transporting device 4 and a row arrangement 6 of terminal stations 61 arranged in a row along the local main conveying direction 83 of the sorter.

The pick-up device 2 comprises a chute 23 and an intermediate store 21. The chute 23 is designed to take over the piece goods 5 from the chute 81 and to transfer them to the intermediate store. The intermediate store 21 is designed to take over the piece goods from the chute 23, to store them temporarily and to deliver them to the transport device 4. The intermediate store 21 comprises an openable floor hatch designed as a discharge chute through which the piece goods 5 can be discharged. The bottom hatch can comprise, for example, a double drop flap or a single drop flap on which the piece goods preferably rest during their intermediate storage and through which the piece goods are discharged from the intermediate store to the transport device. According to other variants the intermediate store 21 comprises a belt conveyor which is designed to discharge the piece goods 5 into the transport device 4. In another variant the intermediate store 21 is designed to push the piece goods 5 out of the intermediate store 21 by means of a pushing device and thus to transfer them to the transport device 4. In a further variant the intermediate store 21 comprises a horizontally displaceable support surface on which the piece goods 5 rest and which is automatically displaceable under the chute 23 so that a piece goods resting on the support surface is prevented by the lower end of the chute 23 from moving with the support surface under the chute 23 until it is thus thrown off the support surface and thus off the intermediate store and transferred to the transport device 4. In one variant, the receiving device 2 does not comprise an intermediate store 21, but the chute 23 is designed to transfer the piece goods 5 directly to the transport device 4.

The transport device 4 comprises a transport unit 41 which is movable to the intermediate store 21 or to each of the terminal stations 61 arranged in the row for receiving the piece goods 5. In the variant in which the receiving device 2 does not comprise an intermediate store, the transport device 4 is designed to move the transport unit 41 to the chute 23 to a suitable position in order to take over the piece goods directly from the chute 23. In a further variant the piece goods 5 are transferred directly from the chute 81 to the transport unit 41. In this case, the end position device can be defined as an end position device comprising the chute 81, wherein the chute 81 is configured as or comprises a pick-up device 2.

The transport device 4 is designed to take over the piece goods 5 delivered by the receiving device 2 and to transport them with the transport unit 41 to a desired one of the terminal stations 61 of the row arrangement 6 and to deliver them to this desired terminal station 61.

In the embodiment shown in FIG. 2, the transport device 4 is track-guided. This means that the transport device comprises a track 43, for example a rail, a groove or a channel, which cooperates with the transport unit 41, for example positively, so that the transport unit 41 can be guided along the track 43. In this case, the transport unit 41 can be designed as a sliding carriage. In alternative variants, the transport unit is not track-guided, but is designed as an AGV, for example.

According to one embodiment example, the transport unit 41 comprises its own drive 49, which is configured to actively drive the transport unit 41 to move it to the desired terminal station 61.

According to one variant, the transport unit is passively designed. For example, the transport device comprises a stationary mounted drive that does not travel with the transport unit but acts on it to move it to the desired end point. Examples of such drives are linear drives arranged along the track or an electrically or otherwise driven cable pull or toothed belt pull system that pulls the transport unit 41 in the desired direction like a cableway.

In the embodiment shown in FIG. 2, the transport unit 41 comprises a belt conveyor 45 which is designed to discharge the piece goods 5 from the transport unit 41. The belt conveyor 45 comprises a conveyor belt on which the piece goods rest while being transported to the desired end point. The belt conveyor 45 comprises separating elements 47, which define at least one segment, or which divide the belt conveyor into segments. A segment receives a piece good 5. According to one variant, the conveyor belt is unsegmented. In further variants the transport unit 41 comprises another discharge mechanism, for example a discharge chute with an openable bottom hatch, which for example comprises a double drop flap, on which the piece goods 5 rests during transport to the desired terminal station 61, and through which the piece goods 5 can be discharged into the desired end point, according to the Bombay principle. Instead of a double drop flap, the bottom hatch may also comprise a single drop flap. In further variants the transport unit 41 comprises a support surface on which the piece goods 5 rests during the transport to the desired terminal station 61, as well as a pushing mechanism which pushes the piece goods 5 down from a support surface in order to drop it into a desired final location.

In the example shown in FIG. 2, the row arrangement 6 of the terminal stations 61 at the sorter outlet 81 is arranged transversely, for example orthogonally, to the local main conveying direction 83 of the sorter 8. The transport unit 41 can also be moved transversely to the local main conveying direction 83 of the sorter 8 in accordance with the arrangement of the row arrangement 6, in order to be able to deliver the piece goods 5 to the desired terminal station 61. According to an embodiment example, the terminal stations 61 are arranged in a straight row arrangement 6.

In the example shown in FIG. 2, the transport unit 41 is assigned a single linear row arrangement 6, and the transport device 4 is set up to deliver piece goods 5 exclusively to the terminal station 61 of this row arrangement 6. Thus, a single linear row arrangement 6 of terminal positions 61 can be assigned to each sorter outlet 81 or, alternatively, to each pair of sorter outlets, which can be operated by a linearly displaceable transport unit 41. On the one hand, this allows a simple and expandable end point concept and, on the other hand, the accommodation of a high number of end points in a limited area. In one variant, however, the transport unit is assigned two or more than two rows of end stations, and the transport device 4 is set up to discharge piece goods 5 into the end stations of these two or more rows. This means that fewer transport units are required per row.

In the example shown in FIG. 2, the end position device 1 comprises exactly one intermediate store 21 and one transport unit 41, which allows a high degree of flexibility with little effort. By the receiving device 2 comprising more than one intermediate store 21 and/or by the transport device 4 comprising more than one transport unit 41, the flexibility for the sorting of piece goods 5 into the terminal stations 61 can be further increased.

In the embodiment example shown in FIG. 2, the end position device 1 also comprises at least one drawer device 63 designed as a drawer silo. In the drawer device 63, the terminal stations 61 arranged in a row are arranged. The drawer device 63 can be pulled out in the longitudinal direction of the row arrangement. This allows convenient access for maintenance of the end stations even under confined conditions of closely arranged end stations. In one embodiment, the drawer assembly comprises two drawers which are extendable in exactly opposite directions and, when retracted, have their front ends adjacent to each other so that the end locations are arranged in a single one-dimensional line in the drawers.

In the embodiment example shown in FIG. 2, the end station device 1 further comprises a collecting belt conveyor device 7 arranged below the row arrangement and having at least one collecting belt 71. The terminal stations 61 comprise a discharge mechanism for discharging the piece goods 5 contained in a terminal station 61 in a group. In the present embodiment, this mechanism is designed as an openable floor hatch comprising a double drop flap. Instead of a double drop flap, the bottom hatch can also comprise a single drop flap. Instead of an openable bottom hatch, other mechanisms can be implemented according to further embodiments, for example a conveyor belt mechanism that conveys the unit loads out of an end station, a tilting mechanism that tilts an end station to empty the unit loads contained therein in a group, or a pushing mechanism that pushes the unit loads in a group out of an end station. The collecting belt conveyor device 7 is designed so that each of the terminal stations 61 of the end station device 1 can discharge the piece goods 5 contained therein in a group onto the collecting belt conveyor device 7. The collecting belt conveyor 7 is designed to transport the piece goods 5 in the group.

In the example embodiment shown in FIG. 2, the terminal device 1 further comprises a control device 3 adapted to control the pick-up device 2 and the transport device 4 and to affect the transfer of the piece 5 from the pick-up device 2 to the transport device 4 and the delivery of the piece 5 from the transport device 4 to the desired terminal station 61.

The control device 3 is also adapted to control the end position device 1 in such a way that at any time a maximum of one piece of good 5 is received in the intermediate store 21. For example, the control device 3 is adapted to determine or remember whether the intermediate store 21 is occupied and, if it is occupied, not to deliver any further piece goods 5 to this intermediate store 21.

In one variant the control device 3 is adapted to control the end position device 1 in such a way that at one time also several piece goods are received simultaneously in the intermediate storage, if these have to be sorted into the same end position. Preferably the control device is adapted to recognize that these piece goods have to be sorted into the same final position. Preferably, the control device is adapted to recognize that these piece goods are sufficiently small to be taken into the buffer at the same time.

In further variants, the functionality of the control device 3 is not accommodated in the terminal device 1. In this case, the sorting system 100 or the terminal device 10 may comprise a central control device 30 which performs this functionality and further functionalities for controlling the sorting system or the terminal device.

According to a further example, the control device 3 or the central control device 30 is adapted to control the end position device 1 and/or the end position device 10 and/or the sorting unit 100 in such a way that a first and a second piece of material delivered by the sorter to the receiving device 2 are simultaneously received in the intermediate store 21, provided that the first and the second piece of material are to be sorted into the same terminal station 61. The control device 3 or the central control device 30 is preferably further adapted to control the end position device 1 and/or the end position device 10 and/or the sorting installation 100 in such a way that it is prevented that between the first and the second piece goods a further piece good is delivered by the sorter 8 to the receiving device 2, which is to be sorted into a different end position.

According to a further embodiment, the control device 3 is adapted to cause the terminal device 1 and/or the terminal device 10 and/or the sorting system 100 to simultaneously store a first and a second item delivered by the sorter 8 to the receiving device 2 in the intermediate store 21, provided that they are to be sorted into the same terminal station 61.

According to further examples, after being dropped from the sorter carrier or other load carrier, the piece goods 5 are temporarily stored in the intermediate store 21 of the terminal devices 1. After this, the unit loads are transferred to their transport unit 41 in each end-of-line device. This transports the piece goods to the terminal stations 61 arranged transversely or orthogonally to the sorter and discharges them there. The terminal stations 61 are preferably close together and perpendicular to the transport direction of the sorter 8. If a terminal station 61 is full, it is emptied downwards onto one of the collecting belts 71. The contents are transported as bulk material to central packing units where the piece goods are sorted and packed in groups into transport containers.

According to further embodiment examples, the piece goods 5 are actively transported to the terminal stations 61. This minimizes slippage of the piece goods and a very high packing density can be achieved and more end stations can be accommodated in a given area.

According to further embodiments, after the discharge from a load carrier designed as a sorter carrier, storage takes place in the intermediate store 21, in order to decouple the sorter 8 from the multiple end station 1 Thus, re-circulation on the sorter 8 can be prevented or minimized. Depending on the application, one or more buffer stores may be implemented per terminal device. The buffer also serves to calm down the piece goods 5 after their dynamic discharge from the sorter 8 and a subsequent sliding process.

According to further embodiments, the sorter comprises at least one pair of sorter outputs, each having a lateral sorter output on either side of a discharge point of the sorter. A terminal device is connected to each of the sorter outputs of the pair of sorter outputs according to an embodiment of the invention.

According to further embodiments, a part of a terminal device is arranged under the sorter in order to utilize the space as optimally as possible.

With reference to FIGS. 1, according to an example of an embodiment, a piece good 5 is transported on a load carrier 89 of the sorter 8 to a sorter exit 81, which is assigned to a destination address or destination of this piece good 5. The piece goods 5 are transferred from the load carrier 89 to a receiving unit 2 of this terminal 81. According to the embodiment example, the piece goods are temporarily stored in an intermediate store 21 by the receiving unit 2 of this terminal. A transport unit 41 of a transport device 4 is moved to or below the intermediate store 21 or is already positioned there. The piece goods 5 are transferred from the intermediate store 21 to the transport unit 41. The transport unit 41 transports the piece goods to a terminal station 61, which is assigned to the destination address or destination of this piece goods 5. The piece goods are then transferred by the transport unit to this terminal station 61. In this way, unit loads can be accumulated in the terminal stations 61, each of which has the same destination address or destination. In one variant, the terminal stations 61 are transported away and emptied. According to a further variant of this example, the piece goods are emptied from each terminal station 61 in a group onto a collecting belt 71, transported away as a group by means of the collecting belt 71 and processed further as a group. In a further variant, the piece goods are not temporarily stored by an intermediate store of the receiving device 2, but are transferred directly from the receiving device 2 to the intermediate store 21, for example by means of a chute 23.

Although the invention has been further illustrated and described in detail by the preferred embodiment example, the invention is not limited by the disclosed examples. Variations thereof may be derived by the skilled person without departing from the scope of protection of the invention as defined by the following claims.

1.-18. (canceled)

19. Terminal device for a sorting plant for sorting piece goods, comprising:
a receiving device;
a transport device;
and a row arrangement of terminal stations arranged in a row;
wherein the receiving device is configured to receive piece goods from a sorter outlet of a sorter of the sorting plant and to deliver the piece goods to the transport device;
wherein the transport device includes a transport unit movable to each of the terminal stations arranged in the row; and
wherein the transport device is configured to take over the piece goods delivered by the receiving device and to transport the piece goods with the transport unit to a desired terminal station of the terminal stations arranged in the row and to deliver the piece goods to the desired terminal station.

20. The terminal device according to claim 19, wherein the receiving device comprises an intermediate store in which the piece goods received by the sorter outlet can be temporarily stored, and the transport device is configured to move the transport unit to the intermediate store, and the intermediate store is configured to deliver the piece goods to the transport unit.

21. The terminal device according to claim 19, wherein the sorter includes a plurality of the sorter outlets and is configured to discharge the piece goods laterally to the main conveying direction of the sorter or vertically downwards to the main conveying direction of the sorter from the plurality sorter outlets.

22. The terminal device according to claim 21, wherein the row arrangement of terminal stations is at the sorter outlet and is arranged transversely to the main conveying direction of the sorter.

23. The terminal device according to claim 19, wherein the row arrangement includes a single linear row arrangement associated with the transport unit and the transport device is configured to deliver the piece goods exclusively into the terminal stations of this row arrangement.

24. The terminal device according to claim 19, wherein the transport device further includes a drive configured to actively drive the transport unit.

25. The terminal device according to claim 19, wherein the transport unit is configured as a sliding carriage configured to be guided in a track.

26. The terminal device according to claim 19, further comprising:
a control device configured to control the receiving device and the transport device and to affect the transfer of the piece goods from the receiving device into the transport device and the delivery of the piece goods from the transport device into the desired terminal station.

27. The terminal device according to claim 26, wherein the control device is configured to control the terminal device such that at anytime a maximum of one piece good of the piece goods is received in an intermediate store in which the piece good can be temporarily stored.

28. The terminal device according to claim 27, wherein the control device is configured to cause the terminal device and/or the end station setup and/or the sorting plant to store a first piece good and a second piece good of the piece goods delivered from the sorter to the receiving device simultaneously in the intermediate store, provided that the first and second piece goods are to be sorted into the same terminal station.

29. The terminal device according to claim 19, further comprising:
a drawer device in which the terminal stations arranged in a row are arranged and which is extendable.

30. A terminal device according to claim 19, further comprising:
a collecting belt conveyor device arranged below the row arrangement, wherein each of the terminal stations of the terminal device is configured to discharge the piece goods contained therein in a group onto the collecting belt conveyor device and the collecting belt conveyor device is configured to transport away the piece goods in the group.

31. An end station setup, comprising:
one or more terminal devices according to claim 19, each of the terminal devices being configured to cooperate with a respective sorter outlet of the sorter to receive the piece goods from the sorter outlet and to deliver the piece goods to the transport device.

32. A sorting system comprising the sorter and one or more terminal devices according to claim 19 or one or more of the end station setup according to claim 31.

33. A method for sorting piece goods, comprising:
transferring piece goods from a sorter outlet of a sorter to a receiving device of a terminal device;
dispensing of the piece goods from the receiving device to a transport unit of a transport device, the transport unit being assigned a row arrangement of terminal stations arranged in a row, and the transport unit being movable to each terminal station arranged in a row arrangement; and
transporting the piece goods delivered to the transport unit via the transport unit to a desired terminal station of the terminal stations arranged in the row and transferring the piece goods from the transport unit to the desired terminal station.

34. A sorting system, comprising:
a sorter; and
a terminal device;
wherein the terminal device includes a receiving device, a transport device and a row arrangement of terminal stations arranged in a row;
wherein the receiving device is configured to receive piece goods from a sorter outlet of the sorter of a sorting plant and to deliver the piece goods to the transport device;
wherein the transport device includes a transport unit movable to each of the terminal stations arranged in the row; and
wherein the transport device is configured to take over the piece goods delivered by the receiving device and to transport the piece goods with the transport unit to a desired terminal station of the terminal stations arranged in the row and to deliver the piece goods to the desired terminal station.

35. A sorting system according to claim 34, wherein the sorter includes several sorter outlets and is configured to discharge the piece goods from the sorter outlets laterally to a main conveying direction of the sorter or vertically downwardly to a main conveying direction of the sorter.

36. A sorting system according to claim 34, wherein the row arrangement of the terminal stations at the sorter outlet is arranged transversely to the main conveying direction of the sorter.
